(19) United States
(12) Patent Application Publication
(10) Pub. No.: US 2011/0254918 A1
(43) Pub. Date: Oct. 20, 2011

(54) STEREOSCOPIC SYSTEM, AND IMAGE PROCESSING APPARATUS AND METHOD FOR ENHANCING PERCEIVED DEPTH IN STEREOSCOPIC IMAGES

(76) Inventor: Hsiu-Ping CHOU, Taipei City (TW)

(21) Appl. No.: 13/018,666

(22) Filed: Feb. 1, 2011

(30) Foreign Application Priority Data
Apr. 15, 2010 (TW) 0099111781

(51) Int. Cl. H04N 13/00

(52) U.S. Cl. 348/43; 348/E13.064

(57) ABSTRACT

A stereoscopic system includes: a storage device; an image transforming module coupled to the storage device to receive therefrom image frame data of correlated first and second image sequences that are acquired from a source video stream, and configured to apply at least one of geometric distortion and geometric tilt processes to the image frame data of at least one of the first and second image sequences for outputting image frame data of corresponding first and second intermediate image sequences; a stereoscopic image sequence generating module coupled to the image transforming module for receiving the image frame data of the first and second intermediate image sequences therefrom, and configured to process the image frame data for obtaining image frame data of a stereoscopic image sequence; and a stereoscopic viewing device coupled to the stereoscopic image sequence generating module for enabling viewing of the stereoscopic image sequence by a user.

### CROSS-REFERENCE TO RELATED APPLICATION

This application claims priority of Taiwanese Application No. 099111781, filed on Apr. 15, 2010.

### BACKGROUND OF THE INVENTION

1. Field of the Invention

The present invention relates to a stereoscopic system, an image processing apparatus, and a method for processing stereoscopic images, more particularly to a stereoscopic system, an image processing apparatus, and a method for enhancing perceived depth in stereoscopic images.

2. Description of the Related Art

There are many techniques in the art of stereoscopic effect generation. The Pulfrich effect is a stereoscopic effect through which objects in a stereoscopic image are viewed as having depth or three dimensions. The Pulfrich effect is achieved by reducing retinal illumination in one of the eyes to thereby yield a time difference between signals transmitted from the retinas to the brain.

However, the objects are seen as having depth or three dimensions only when the objects move in a direction perpendicular and horizontal relative to the viewer. That is to say, vertical motions of the objects relative to the viewer will not yield a satisfactory Pulfrich effect.

### SUMMARY OF THE INVENTION

Therefore, an object of the present invention is to provide a stereoscopic system for enhancing perceived depth in stereoscopic images.

Accordingly, a stereoscopic system of the present invention includes a storage device, an image transforming module, a stereoscopic image sequence generating module, and a stereoscopic viewing device.

The storage device is for storing image frame data of correlated first and second image sequences that are acquired from a source video stream.

The image transforming module is coupled to the storage device for receiving the image frame data of the first and second image sequences therefrom, and is configured to apply at least one of a geometric distortion process and a geometric tilt process to the image frame data of at least one of the first and second image sequences so as to output image frame data of corresponding first and second intermediate image sequences. Image frames in the first intermediate image sequence are geometrically different from image frames in the second intermediate image sequence.

The stereoscopic image sequence generating module is coupled to the image trans forming module for receiving the image frame data of the first and second intermediate image sequences therefrom, and is configured to process the image frame data of the first and second intermediate image sequences so as to obtain image frame data of a stereoscopic image sequence.

The stereoscopic viewing device is coupled to the stereoscopic image sequence generating module and is configured to enable viewing of the stereoscopic image sequence by a user.

Another object of the present invention is to provide an image processing apparatus for enhancing perceived depth in stereoscopic images.

Accordingly, an image processing apparatus of the present invention includes a storage device, an image transforming module, and a stereoscopic image sequence generating module.

The storage device is for storing image frame data of correlated first and second image sequences that are acquired from a source video stream.

The image transforming module is coupled to the storage device for receiving the image frame data of the first and second image sequences therefrom, and is configured to apply at least one of a geometric distortion process and a geometric tilt process to the image frame data of at least one of the first and second image sequences so as to output image frame data of corresponding first and second intermediate image sequences. Image frames in the first intermediate image sequence are geometrically different from image frames in the second intermediate image sequence.

The stereoscopic image sequence generating module is coupled to the image trans forming module for receiving the image frame data of the first and second intermediate image sequences therefrom, and is configured to process the image frame data of the first and second intermediate image sequences so as to obtain image frame data of a stereoscopic image sequence.

Yet another object of the present invention is to provide a method for enhancing perceived depth in stereoscopic images.

Accordingly, an image processing method of the present invention is to be performed by an image processing apparatus, and includes: a) configuring the image processing apparatus to acquire image frame data of correlated first and second image sequences from a source video stream; b) configuring the image processing apparatus to apply at least one of a geometric distortion process and a geometric tilt process to the image frame data of at least one of the first and second image sequences so as to output image frame data of corresponding first and second intermediate image sequences, wherein image frames in the first intermediate image sequence are geometrically different from image frames in the second intermediate image sequence; and c) configuring the image processing apparatus to process the image frame data of the first and second intermediate image sequences so as to obtain image frame data of a stereoscopic image sequence.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram of the preferred embodiment of a stereoscopic system according to the present invention;

FIG. 2 is a flowchart of the preferred embodiment of a method for enhancing perceived depth in stereoscopic images, according to the present invention;

FIG. 3 is a flowchart to illustrate steps of processing of image frame data of image frames included in a source video stream by the preferred embodiment of an image processing apparatus, according to the present invention;

FIG. 4 is a schematic diagram to illustrate examples of geometric distortion and geometric tilt processes that may be applied to the image frame data of the image frames by the image processing apparatus;

FIG. 5 is a schematic diagram to illustrate that image frames in a first intermediate image sequence obtained are geometrically different from corresponding images frames in a second intermediate image sequence, the first and second intermediate image sequences being obtained by processing the source video stream;

FIG. 6 is a schematic diagram to illustrate a liquid crystal shutter glasses system displaying left-eye and right-eye image sequences, which are obtained from the first and second intermediate image sequences, respectively;

FIG. 7 is a schematic diagram to illustrate a spatial-multiplexing stereoscopic display system displaying the left-eye and right-eye image sequences;

FIG. 8 is a schematic diagram to illustrate a temporal-multiplexing stereoscopic display system displaying the left-eye and right-eye image sequences;

FIG. 9 is a schematic diagram to illustrate a polarizing glasses stereoscopic system displaying the left-eye and right-eye image sequences; and

FIG. 10 is a flowchart to illustrate that perception of a first image frame of the right-eye image sequence by the right eye is slower than that of a corresponding first image frame of the left-eye image sequence by the left eye.

### DETAILED DESCRIPTION OF THE PREFERRED EMBODIMENT

Before the present invention is described in greater detail, it should be noted that like elements are denoted by the same reference numerals throughout the disclosure.

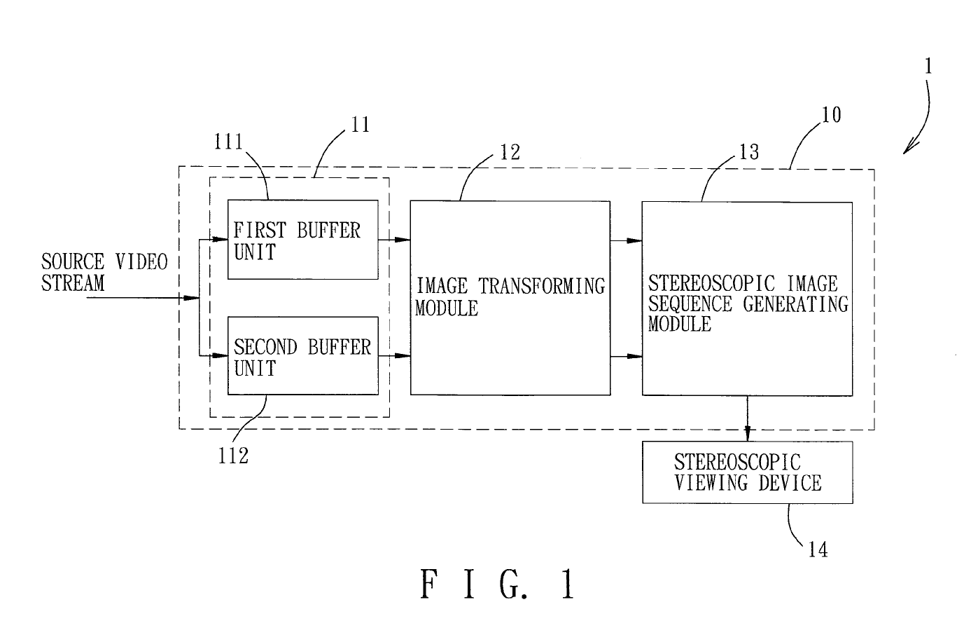

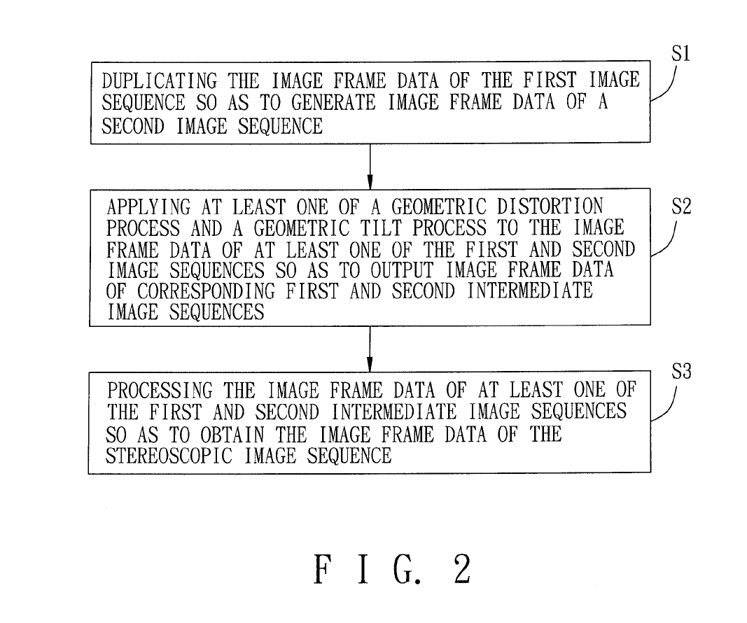

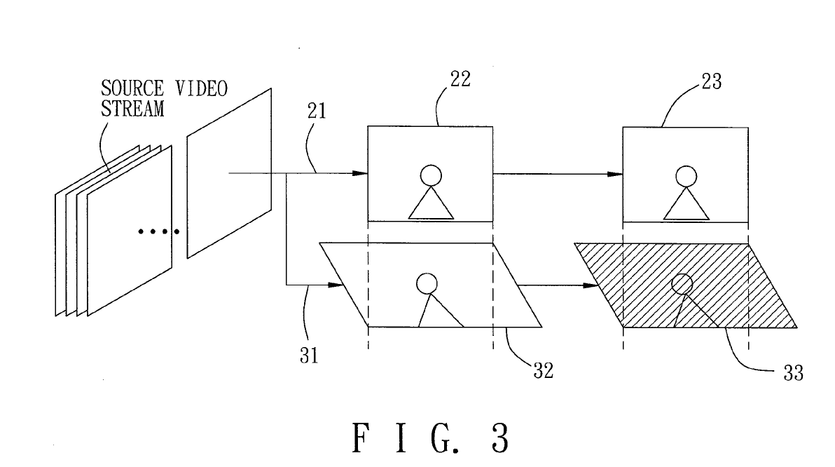

Referring to FIG. 1, the preferred embodiment of a stereoscopic system 1 according to the present invention includes an image processing apparatus 10 including an image acquisition module 11, an image transforming module 12, and a stereoscopic image sequence generating module 13. The image processing apparatus 10 is adapted to receive a source video stream, and is configured to perform steps of the preferred embodiment of an imaging processing method of the present invention, which are shown in FIG. 2, so as to obtain image frame data of a stereoscopic image sequence (see FIG. 3), which includes left-eye and right-eye image sequences 23, 33, from the source video stream.

In the present embodiment, referring to FIG. 3, the source video stream is a two-dimensional video stream containing image frame data of a first image sequence 21. In step S1, the image acquisition module 11 includes first and second buffer units 111, 112, is configured for duplicating the image frame data of the first image sequence 21 so as to generate image frame data of a second image sequence 31, and is configured for storing the image frame data of the first image sequence 21 in the first buffer unit 111 and that of the second image sequence 31 in the second buffer unit 112.

In other embodiments, the source video stream may be a three-dimensional video stream containing image frame data of left-eye and right-eye source-image sequences. The image acquisition module 11 is operable for acquiring image frame data of a first image sequence 21 from the image frame data of one of the left-eye and right-eye source-image sequences, for storing the image frame data of the first image sequence 21 in the first buffer unit 111, for acquiring image frame data of a second image sequence 31 from the image frame data of the other one of the left-eye and right-eye source-image sequences, and for storing the image frame data of the second image sequence 31 in the second buffer unit 112.

In further embodiments, the source video stream may be a two-dimensional video stream may be a two-dimensional video stream, and the image acquisition module 11 is configured to apply a known three-dimensional transformation process to the source video stream so as to acquire the image frame data of the first and second image sequences 21, 31.

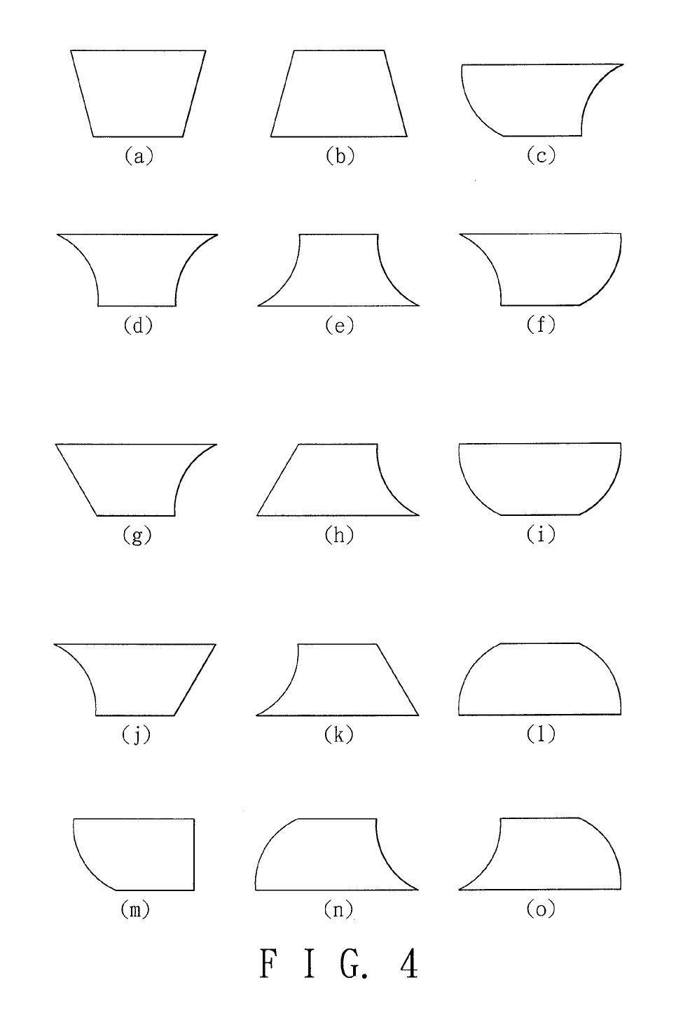

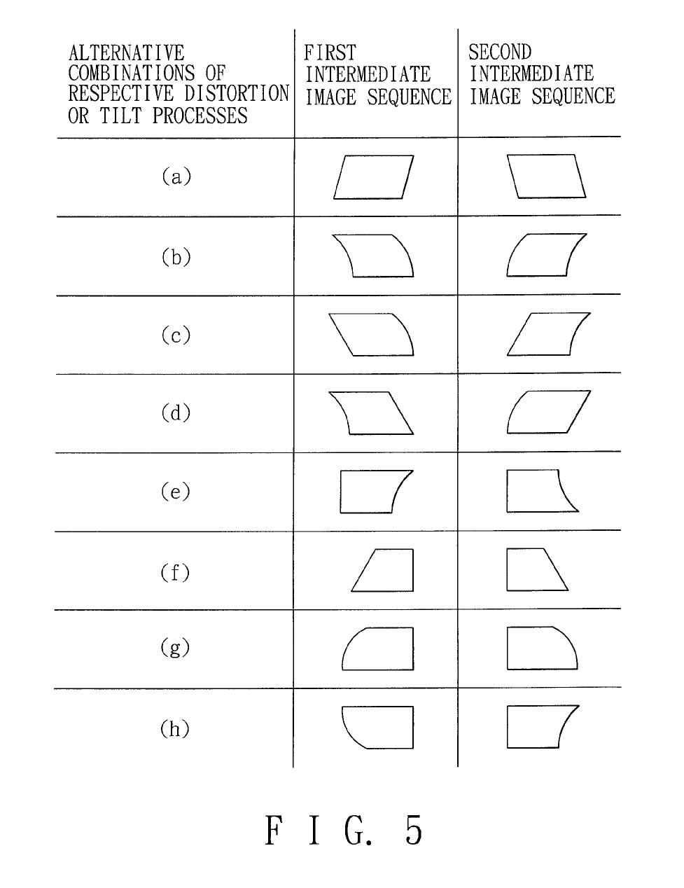

In step S2, the image transforming module 12 of the preferred embodiment, which is coupled to the image acquisition module 11 for receiving the image frame data of the first and second image sequences 21, 31 therefrom, is configured to apply at least one of a geometric distortion process and a geometric tilt process to the image frame data of at least one of the first and second image sequences 21, 31 so as to output image frame data of corresponding first and second intermediate image sequences 22, 32. The first and second intermediate image sequences 22, 32 have an enhanced perceived depth in comparison with the first and second image sequences 21, 31. FIG. 4 shows examples of the geometric distortion and geometric tilt processes that may be applied to the image frame data of the first and second image sequences 21, 31. FIG. 5 shows that image frames in the first intermediate image sequence 22 are geometrically different from images frames in the second intermediate image sequence 32. It is worth noting that corresponding image frames of the first and second intermediate image sequences 22, 32 thus generated produce the Pulfrich effect even when objects therein move in a vertical direction relative to a user. It is to be noted that, in other embodiments, the image transforming module 12 may be configured for applying geometric transformation processes other than geometric distortion and geometric tilt processes to the image frame data of at least one of the first and second image sequences 21, 31 so as to output image frame data of corresponding first and second intermediate image sequences 22, 32.

It is also worth noting that geometric distortion or geometric tilt may be achieved through data processing techniques or through use of specially designed convex or concave lenses.

In step S3, the stereoscopic image sequence generating module 13 is coupled to the image transforming module 12 for receiving the image frame data of the first and second intermediate image sequences 22, 32 therefrom, and is configured to process the image frame data of at least one of the first and second intermediate image sequences 22, 32 so as to obtain the image frame data of the stereoscopic image sequence.

It is to be noted that the stereoscopic image sequence generating module 13 may further be at least one of: configured to process at least one of the first and second intermediate image sequences 22, 32 such that brightness of one of the left-eye and right-eye image sequences 23, 33 is lower than that of the other one of the left-eye and right-eye image sequences 23, 33; configured to process at least one of the first and second intermediate image sequences 22, 32 such that rendering time of one of the left-eye and right-eye image sequences 23, 33 lags that of the other one of the left-eye and right-eye image sequences 23, 33; and configured to apply a spatial shift process to the image frame data of at least one of the first and second image sequences 21, 31; so as to enhance perceived depth of the stereoscopic image sequence.

In the present embodiment, the stereoscopic system 1 further includes a stereoscopic viewing device 14 coupled to the stereoscopic image sequence generating module 13, and configured to enable viewing of the stereoscopic image sequence by the user. Several implementations of the stereoscopic viewing device 14 are described hereinafter. However, implementation of the stereoscopic viewing device 14 is not limited to such. It is worth noting that the image processing apparatus 10 may be integrated into a television controller chip for providing the stereoscopic image sequence to the stereoscopic viewing device 14. Furthermore, in other embodiments, the stereoscopic image sequence generating module 13 may be configured to output the stereoscopic image sequence in a form of a video file for storage, i.e., the stereoscopic viewing device 14 may be omitted in such embodiments.

Pulfrich Glasses Display System: The stereoscopic viewing device 14 may be implemented as a Pulfrich glasses display system including a display unit for showing the stereoscopic image sequence thereon, and a pair of stereoscopic glasses through which the stereoscopic image sequence shown on the display unit is viewed by the user. The stereoscopic glasses have a pair of lens units including first and second lens, respectively. In one modification, the first lens (i.e., a right-eye lens) is darker than the second lens (i.e., a left-eye lens) so as to provide a darkened view. In another modification, the second lens unit includes a light source such that the view through the first lens unit is darker compared to that through the second lens unit.

### Liquid Crystal Shutter Glasses Stereoscopic System:

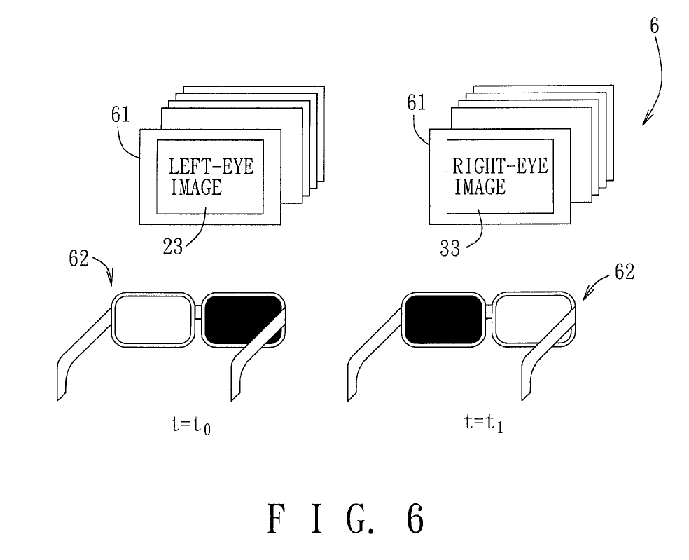

Referring to FIG. 6, the stereoscopic viewing device 14 maybe implemented as a liquid crystal shutter glasses system 6 including a display unit 61 for showing the left-eye and right-eye image sequences 23, 33 thereon at a sufficiently high frame rate using alternate-frame sequencing, and a pair of liquid crystal shutter glasses 62 that operate to block or pass light through lenses thereof in synchronization with showing of the left and right-eye image sequences 23, 33 on the display unit 61.

### Anaglyph Glasses Stereoscopic System:

The stereoscopic viewing device 14 may be implemented as an anaglyph glasses stereoscopic system including a color processor for chromatically processing the left-eye and right-eye image sequences 23, 33 to obtain corresponding chromatically-processed left-eye and right-eye image sequences, a display unit for showing the chromatically-processed left-eye and right-eye image sequences in a superimposed manner, and a pair of anaglyph glasses that enable viewing of the chromatically-processed left-eye image sequence only by the left eye and viewing of the chromatically-processed right-eye image sequence only by the right eye.

### Spatial-Multiplexing Stereoscopic Display System:

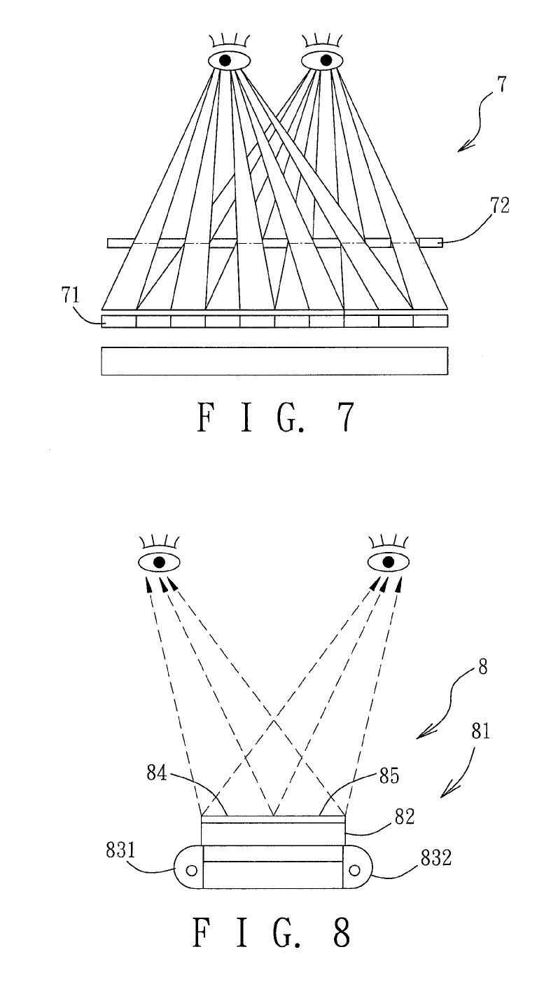

Referring to FIG. 7, the stereoscopic viewing device 14 may be implemented as a spatial-multiplexing stereoscopic display system 7 including a display unit 71 for showing the left-eye and right-eye image sequences 23, 33 in a pixel-interlaced manner using spatial-multiplexing techniques, and an optical element 72 (e.g., an optical lens or an optical barrier) that serves to block or pass light therethrough so as to enable viewing of the left-eye image sequences 23 only by the left eye and viewing of the right-eye image sequence 33 only by the right eye.

### Temporal-Multiplexing Stereoscopic Display System:

Referring to FIG. 8, the stereoscopic viewing device 14 maybe implemented as a temporal-multiplexing stereoscopic display system 8 including a display unit 81 for showing the stereoscopic image sequence thereon.

The display unit 81 includes a display panel 82 for showing the left-eye and right-eye image sequences 23, 33 thereon, first and second backlight modules 831, 832 disposed respectively on two sides of the display panel 82, and a light guide plate 84 and a directional backlight film 85 disposed at an image-forming side of the display panel 82. The light guide plate 84 and the directional backlight film 85 cooperate with the first backlight module 831 such that the left-eye image sequence 23 shown on the display panel 82 is directed to the left eye. The light guide plate 84 and the directional backlight film 85 cooperate with the second backlight module 832 such that the right-eye image sequence 33 shown on the display panel 82 is directed to the right eye.

### Polarized Projection Stereoscopic System

The stereoscopic viewing device 14 may be implemented as a polarized project ion stereoscopic system including first and second image-projecting units, and first and second polarizing lenses. Each of the first and second image-projecting units is operable for projecting a respective one of the left-eye and right-eye image sequences 23, 33 to a viewing site. The first and second polarizing lenses are operatively and respectively associated with the first and second image-projecting units, and each of which polarizes a respective one of the left-eye and right-eye image sequences 23, 33 projected by the first and second image-projecting units such that the left-eye image sequence 23 has a different polarization relative to the right-eye image sequence 33 when projected to the viewing site.

The stereoscopic viewing device 14 may otherwise be implemented as a polarized projection stereoscopic system including a single image-projecting unit operable for alternately projecting sequential image frames of the left-eye and right-eye image sequences 23, 33 at a sufficiently high frame rate, and an active polarizing lens unit operatively associated with the image-projecting unit and operable for polarizing the image frames of the left-eye and right-eye image sequences 23, 33 projected thereby in a manner that the projected left-eye image sequence 23 has a different polarization relative to the projected right-eye image sequence 33.

### Polarizing Glasses Stereoscopic System

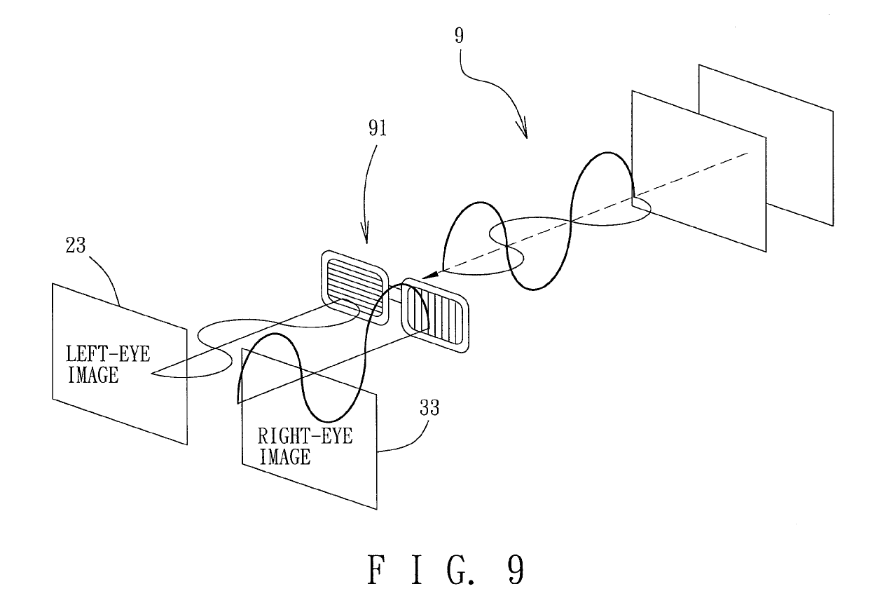

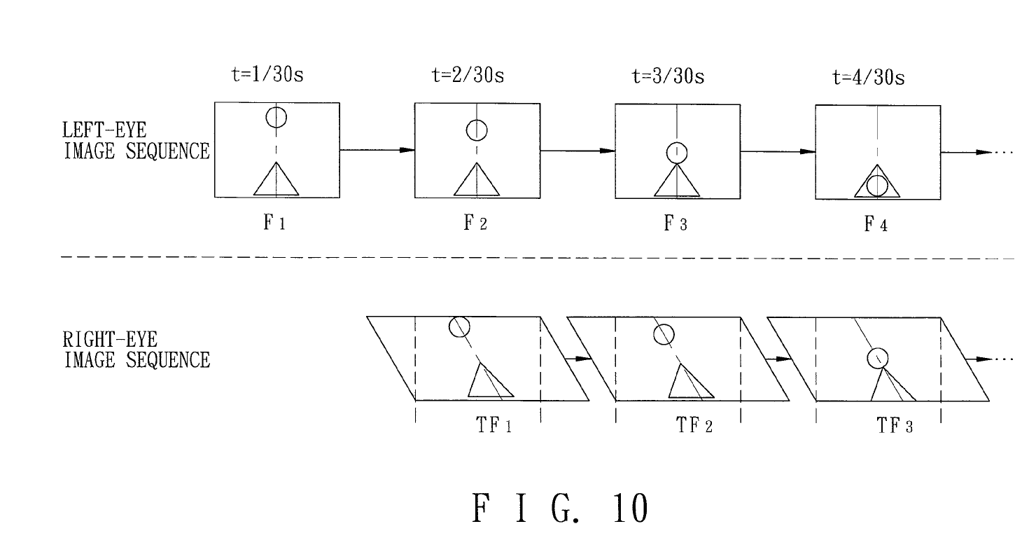

Referring to FIG. 9, the stereoscopic viewing device 14 may be implemented as a polarizing glasses stereoscopic system 9 including a liquid crystal display unit, an optical element, and a pair of polarizing glasses 91. The liquid crystal display unit has a first set of scan lines for showing the left-eye image sequence 23 and a second set of scan lines for showing the right-eye image sequence 33. The optical element is operatively associated with the liquid crystal display unit for polarizing the left-eye and right-eye image sequences displayed thereby such that the left-eye image sequence has a different polarization relative to the right-eye image sequence. The pair of polarizing glasses 91 is operatively associated with the liquid crystal display unit and the optical element, and has a first lens unit for enabling viewing of the left-eye image sequence 23 only by the left eye and a second lens unit for enabling viewing of the right-eye image sequence 33 only by the right eye.

### Head-Mount Display Stereoscopic System

The stereoscopic viewing device 14 may be exemplified as a head-mount display stereoscopic system for displaying the left-eye and right-eye image sequences 23, 33 to the left and right eyes, respectively.

Referring to FIG. 10, since the right-eye image sequence 33 is processed, or viewed to be, darker than the left-eye image sequence 23, perception of a first image frame (TF₁) of the right-eye image sequence 33 by the right eye is slower than that of a corresponding first image frame (F₁) of the left-eye image sequence 23 by the left eye. In the example shown in FIG. 10, perception of the first image frame (TF₁) of the right-eye image sequence 33 by the right eye and that of a second image frame (F₂) of the left-eye image sequence 23 by the left eye occur almost concurrently.

In the same example, a circle is moving toward a triangle. It is apparent that, in the first image frame (F₁) of the left-eye image sequence 23, the circle and the triangle are in vertical alignment (i.e., absence of a horizontal displacement therebetween), and that, in the first image frame (TF₁) of the right-eye image sequence 33, the same are shown to have a horizontal displacement, which is indicated by a slanted dashed-line connecting the circle and the triangle. When viewed with the Pulfrich effect by the user, the horizontal displacement between the circle and the triangle in the right-eye image sequence 33 will produce the Pulfrich effect even when the circle moves in the vertical direction relative to the user.

In summary, the first and second intermediate image sequences 22, 32 outputted by the image transforming module 12 are geometrically different from each other, thereby enhancing perceived depth of the stereoscopic image sequence, and producing the Pulfrich effect even when objects in the stereoscopic image sequence move in the vertical direction relative to the user.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A stereoscopic system comprising:
a storage device for storing image frame data of correlated first and second image sequences that are acquired from a source video stream;
an image trans forming module coupled to said storage device for receiving the image frame data of the first and second image sequences therefrom, and configured to apply at least one of a geometric distortion process and a geometric tilt process to the image frame data of at least one of the first and second image sequences so as to output image frame data of corresponding first and second intermediate image sequences, wherein image frames in the first intermediate image sequence are geometrically different from image frames in the second intermediate image sequence;
a stereoscopic image sequence generating module coupled to said image trans forming module for receiving the image frame data of the first and second intermediate image sequences therefrom, and configured to process the image frame data of the first and second intermediate image sequences so as to obtain image frame data of a stereoscopic image sequence; and
a stereoscopic viewing device coupled to said stereoscopic image sequence generating module and configured to enable viewing of the stereoscopic image sequence with Pulfrich effect by a user.

2. The stereoscopic system as claimed in claim 1, wherein the source video stream is a two-dimensional video stream, and the second image sequence is a duplicate of the first image sequence.

3. The stereoscopic system as claimed in claim 1, wherein the source video stream is a three-dimensional video stream, and the first and second image sequences are left-eye and right-eye source-image sequences of the source video stream.

4. The stereoscopic system as claimed in claim 1, wherein said stereoscopic viewing device includes a display unit for showing the stereoscopic image sequence thereon, and a pair of stereoscopic glasses through which the stereoscopic image sequence shown on said display unit is viewed by the user, said stereoscopic glasses having a pair of lens units, one of said lens units being configured to provide a darkened view compared to the other of said lens units.

5. The stereoscopic system as claimed in claim 4, wherein said one of said lens units includes a first lens and the other of said lens units includes a second lens, said first lens being darker than said second lens.

6. The stereoscopic system as claimed in claim 4, wherein the other of said lens units includes a light source such that the view through said one of said lens units is darker compared to that through the other of said lens units.

7. The stereoscopic system as claimed in claim 1, wherein the stereoscopic image sequence includes left-eye and right-eye image sequences, and said stereoscopic image sequence generating module is configured to process the image frame data of at least one of the first and second intermediate image sequences such that brightness of one of the left-eye and right-eye image sequences is lower than that of the other one of the left-eye and right-eye image sequences.

8. The stereoscopic system as claimed in claim 1, wherein the stereoscopic image sequence includes left-eye and right-eye image sequences, and said stereoscopic image sequence generating module is configured to process the image frame data of at least one of the first and second intermediate image sequences such that rendering time of one of the left-eye and right-eye image sequences lags that of the other one of the left-eye and right-eye image sequences.

9. The stereoscopic system as claimed in claim 1, wherein said image transforming module is further configured to apply a spatial shift process to the image frame data of at least one of the first and second image sequences.

10. The stereoscopic system as claimed in claim 1, wherein the stereoscopic image sequence includes left-eye and right-eye image sequences, and said stereoscopic viewing device includes a display unit for showing the left-eye and right-eye image sequences thereon at a frame rate using alternate-frame sequencing, and a pair of liquid crystal shutter glasses that operate to block or pass light through lenses thereof in synchronization with showing of the left-eye and right-eye image sequences on said display unit.

11. The stereoscopic system as claimed in claim 1, wherein the stereoscopic image sequence includes left-eye and right-eye image sequences, and said stereoscopic viewing device includes a color processor for chromatically processing the left-eye and right-eye image sequences to obtain corresponding chromatically-processed left-eye and right-eye image sequences, a display unit for showing the chromatically-processed left-eye and right-eye image sequences in a superimposed manner, and a pair of anaglyph glasses that enable viewing of the left-eye image sequence only by the left eye and viewing of the right-eye image sequence only by the right eye.

12. The stereoscopic system as claimed in claim 1, wherein the stereoscopic image sequence includes left-eye and right-eye image sequences, and said stereoscopic viewing device includes a display unit for showing the left-eye and right-eye image sequences in a pixel-interlaced manner using spatial-multiplexing techniques, and an optical element that serves to block or pass light therethrough so as to enable viewing of the left-eye image sequence only by the left eye and viewing of the right-eye image sequence only by the right eye.

13. The stereoscopic system as claimed in claim 1, wherein the stereoscopic image sequence includes left-eye and right-eye image sequences, and said stereoscopic viewing device includes a display unit for showing the stereoscopic image sequence thereon, said display unit including a display panel for showing the left-eye and right-eye image sequences thereon, first and second backlight modules disposed respectively on two sides of said display panel, and alight guide plate and a directional backlight film disposed at an image-forming side of said display panel,
said light guide plate and said directional backlight film cooperating with said first backlight module such that the left-eye image sequence shown on said display panel is directed to the left eye,
said light guide plate and said directional backlight film further cooperating with said second backlight module such that the right-eye image sequence shown on said display panel is directed to the right eye.

14. The stereoscopic system as claimed in claim 1, wherein the stereoscopic image sequence includes left-eye and right-eye image sequences, and said stereoscopic viewing device includes
first and second image-projecting units, each operable for projecting a respective one of the left-eye and right-eye image sequences to a viewing site, and
first and second polarizing lenses operatively and respectively associated with said first and second image-projecting units, each of said first and second polarizing lenses polarizing one of the left-eye and right-eye image sequences projected by the respective one of said first and second image-projecting units such that the left-eye image sequence has a different polarization relative to the right-eye image sequence when projected to the viewing site.

15. The stereoscopic system as claimed in claim 1, wherein the stereoscopic image sequence includes left-eye and right-eye image sequences, and said stereoscopic viewing device includes
an image-projecting unit operable for alternately projecting sequential image frames of the left-eye and right-eye image sequences at a frame rate, and
an active polarizing lens unit operatively associated with said image-projecting unit and operable for polarizing the image frames of the left-eye and right-eye image sequences projected thereby in a manner that the projected left-eye image sequence has a different polarization relative to the projected right-eye image sequence.

16. The stereoscopic system as claimed in claim 1, wherein the stereoscopic image sequence includes left-eye and right-eye image sequences, and said stereoscopic viewing device includes
a liquid crystal display unit having a first set of scan lines for showing the left-eye image sequence and a second set of scan lines for displaying the right-eye image sequence,
an optical element operatively associated with said liquid crystal display unit for polarizing the left-eye and right-eye image sequences displayed thereby such that the left-eye image sequence has a different polarization relative to the right-eye image sequence, and
a pair of polarizing glasses operatively associated with said liquid crystal display unit and said optical element, and having a first lens unit for enabling viewing of the left-eye image sequence only by the left eye and a second lens unit for enabling viewing of the right-eye image sequence only by the right eyes.

17. The stereoscopic system as claimed in claim 1, wherein said stereoscopic viewing device includes a head-mounted display.

18. An image processing apparatus comprising:
a storage device for storing image frame data of correlated first and second image sequences that are acquired from a source video stream;
an image transforming module coupled to said storage device for receiving the image frame data of the first and second image sequences therefrom, and configured to apply at least one of a geometric distortion process and a geometric tilt process to the image frame data of at least one of the first and second image sequences so as to output image frame data of corresponding first and second intermediate image sequences, wherein image frames in the first intermediate image sequence are geometrically different from image frames in the second intermediate image sequence; and
a stereoscopic image sequence generating module coupled to said image transforming module for receiving the image frame data of the first and second intermediate image sequences therefrom, and configured to process the image frame data of the first and second intermediate image sequences so as to obtain image frame data of a stereoscopic image sequence.

19. The image processing apparatus as claimed in claim 18, wherein the source video stream is a two-dimensional video stream, and the second image sequence is a duplicate of the first image sequence.

20. The image processing apparatus as claimed in claim 18, wherein the source video stream is a three-dimensional video stream, and the first and second image sequences are left-eye and right-eye source-image sequences of the source video stream.

21. The image processing apparatus as claimed in claim 18, wherein the stereoscopic image sequence includes left-eye and right-eye image sequences, and said stereoscopic image sequence generating module is configured to process the image frame data of at least one of the first and second intermediate image sequences such that brightness of one of the left-eye and right-eye image sequences is lower than that of the other one of the left-eye and right-eye image sequences.

22. The image processing apparatus as claimed in claim 18, wherein the stereoscopic image sequence includes left-eye and right-eye image sequences, and said stereoscopic image sequence generating module is configured to process the image frame data of at least one of the first and second intermediate image sequences such that rendering time of one of the left-eye and right-eye image sequences lags that of the other one of the left-eye and right-eye image sequences.

23. The image processing apparatus as claimed in claim 18, wherein said image transforming module is further configured to apply a spatial shift process to the image frame data of at least one of the first and second image sequences.

24. The image processing apparatus as claimed in claim 18, wherein said stereoscopic image sequence generating module is configured to output the stereoscopic image sequence in a form of a video file.

25. The image processing apparatus as claimed in claim 18, which is integrated into a television controller chip.

26. An image processing method to be performed by an image processing apparatus, comprising:
a) configuring the image processing apparatus to acquire image frame data of correlated first and second image sequences from a source video stream;
b) configuring the image processing apparatus to apply at least one of a geometric distortion process and a geometric tilt process to the image frame data of at least one of the first and second image sequences so as to output image frame data of corresponding first and second intermediate image sequences, wherein image frames in the first intermediate image sequence are geometrically different from image frames in the second intermediate image sequence; and
c) configuring the image processing apparatus to process the image frame data of the first and second intermediate image sequences so as to obtain image frame data of a stereoscopic image sequence.

27. The image processing method as claimed in claim 26, wherein the source video stream is a two-dimensional video stream, and the second image sequence is a duplicate of the first image sequence.

28. The image processing method as claimed in claim 26, wherein the source video stream is a three-dimensional video stream, and the first and second image sequences are left-eye and right-eye source-image sequences of the source video stream.

29. The image processing method as claimed in claim 26, wherein the stereoscopic image sequence includes left-eye and right-eye image sequences, and in step c), the image processing apparatus is configured to process the image frame data of at least one of the first and second intermediate image sequences such that brightness of one of the left-eye and right-eye image sequences is lower than that of the other one of the left-eye and right-eye image sequences.

30. The image processing method as claimed in claim 26, wherein the stereoscopic image sequence includes left-eye and right-eye image sequences, and in step c), the image processing apparatus is configured to process the image frame data of at least one of the first and second intermediate image sequences such that rendering time of one of the left-eye and right-eye image sequences lags that of the other one of the left-eye and right-eye image sequences.

31. The image processing method as claimed in claim 26, wherein, in step b), the image processing apparatus is further configured to apply a spatial shift process to the image frame data of at least one of the first and second image sequences.

32. The image processing method as claimed in claim 26, further comprising:
d) outputting the stereoscopic image sequence in a form of a video file.
